(19) United States
(12) Patent Application Publication
(10) Pub. No.: US 2018/0196956 A1
(43) Pub. Date: Jul. 12, 2018

(54) SECURITY ARCHITECTURE AND METHOD

(71) Applicant: Renesas Electronics America Inc., Santa Clara, CA (US)

(72) Inventor: Sudhin Mishra, San Jose, CA (US)

(21) Appl. No.: 15/867,365

(22) Filed: Jan. 10, 2018

Related U.S. Application Data
(60) Provisional application No. 62/444,502, filed on Jan. 10, 2017.

(51) Int. Cl. G06F 21/62

(52) U.S. Cl. CPC G06F 21/6218

(57) ABSTRACT

A security architecture and method for a system on a chip or a microcontroller. The method in one embodiment includes a first central processing unit (CPU) specifying a first address. A security attribute for the first address is identified, wherein the security attribute is one of at least four security attributes. The first CPU can be denied access to a memory location identified by the first address based on the identified security attribute.

### RELATED APPLICATIONS

This application claims the domestic benefit under Title 35 of the United States Code § 119(e) of U.S. Provisional Patent Application Ser. No. 62/444,502, entitled “Security Architecture and Method,” filed Jan. 10, 2017, and naming Sudhin Mishra as the inventor, which is hereby incorporated by reference in its entirety and for all purposes as if completely and fully set forth herein.

### BACKGROUND

A system on a chip (SoC) is considered a computer on a chip. A microcontroller unit (MCU) is also considered a computer on a chip. Each takes form in an integrated circuit formed on a semiconductor die. SoCs and MCUs both employ central processing units (CPUs) that execute instructions of embedded software. SoCs typically employ two or more CPUs, while MCUs employ one CPU. Otherwise the contrast between a SoC and an MCU is one of degree. The present invention will be described with reference to SoCs, it being understood the present invention should not be limited thereto.

SoCs vary in their hardware structure. However, nearly all SoCs contain memory components including flash memory, random access memory (RAM), read only memory (ROM), registers, etc., in addition to CPUs. Flash and ROM typically store software and information. The software may include interlinked components such as main applications, functional libraries, hardware abstraction layer (HAL) drivers, communication stacks, real time operating systems (RTOSs), system configuration code, etc. The information, data, and software are often referred to as resources of the SoC.

SoCs include, as noted above, several CPUs for executing instructions of embedded software. The present invention will be described with reference to a SoC that includes two CPUs, it being understood the present invention should not be limited thereto. A typical CPU includes: an arithmetic logic unit (ALU) that performs arithmetic and logic operations according to instructions fetched from memory; registers that supply operands to the ALU and store the results of ALU operations, and; a control unit that directs operations of the CPU. The ALU may include additional components. SoCs also include peripherals such as general purpose timers, general purpose input/output (GPIO) ports, serial communication controllers, etc., that cooperate with the CPU to implement a dedicated function within a larger mechanical or electrical system, often with real-time computing constraints.

Communication subsystems in SoCs enable transmission of data, instructions, and addresses between CPUs, peripherals and memory components. In some SoCs, the communication subsystem takes form of a network on a chip (NoC). NoC technology applies networking theory and methods to the transmission of information between SoC components.

While executing instructions, a CPU implements transactions for accessing memory (e.g., flash, RAM, registers, etc.). For example, a CPU can implement a memory access transaction for reading or writing data to RAM or to a register. Or a CPU can implement a memory access transaction for fetching an instruction from flash memory for execution. Most access transactions include an address phase and a data phase. For the purposes of explanation only, the present invention will presume that all access transactions include an address phase and a data phase. During the address phase, the CPU specifies an address where the CPU will read/write data or fetch an instruction during the subsequent data phase.

### SUMMARY

A security architecture and method for a system on a chip or a microcontroller, which includes a first central processing unit (CPU). The method in one embodiment includes the first CPU specifying a first address during an access transaction. A security attribute for the first address is identified, wherein the security attribute is one of at least four security attributes. Based on the identified security attribute, access to a memory location identified by the first address may be blocked during the access transaction.

### BRIEF DESCRIPTION OF THE DRAWINGS

The present invention may be better understood in its numerous objects, features, and advantages made apparent to those skilled in the art by referencing the accompanying drawings.

FIG. 1 illustrates an example address space for a SoC.

FIG. 2 is block diagram illustrating an example SoC employing one embodiment of the present invention.

FIG. 3 is a block diagram illustrating example trust zone configuration registers employed in the SoC of FIG. 2.

FIG. 4 illustrates an example address space for the SoC of FIG. 2.

FIG. 5 is a block diagram of an example security configuration controller employed in the SoC of FIG. 2.

FIG. 6 is a block diagram of an example hit detector employed in the security configuration controller of FIG. 5.

FIG. 7 is a block diagram of an external authentication unit employed in the SoC of FIG. 2.

FIG. 8 is a flow chart illustrating an example method according to one embodiment of the present invention.

The use of the same reference symbols in different drawings indicates similar or identical items.

### DETAILED DESCRIPTION

SoC resources such as functional libraries, communication stacks, information, data, etc., are stored in memory components (e.g., RAM, flash memory, registers, etc.) and should be protected from unauthorized access by software executing on the CPU. TrustZone-M, which is a security subsystem provided by ARM Holdings plc (ARM), can protect resources against unauthorized access. Unfortunately, as will be more fully described, TrustZone-M has several limitations.

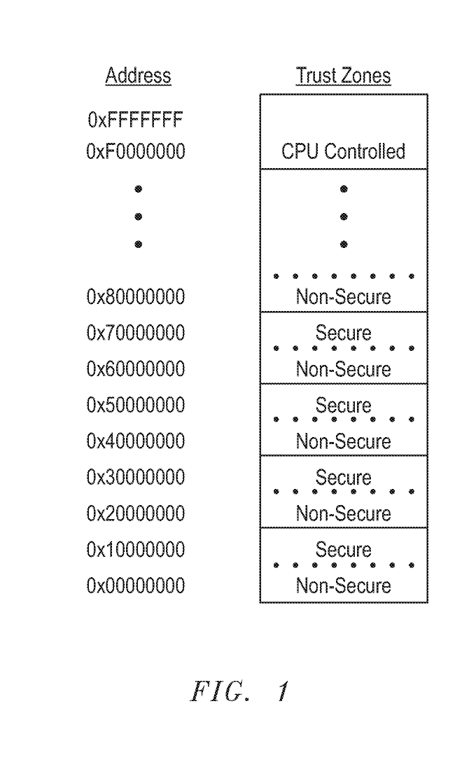

Each SoC has an address space or map, which defines one or more ranges of discrete addresses, each of which corresponds to a physical memory location (e.g., a RAM cell, a register, etc.). Some addresses may correspond to memory locations that are external to the SoC. TrustZone-M (hereinafter TZM) requires a SoC's address space to be partitioned into logical units called trust zones. FIG. 1 illustrates an example SoC address space, which is partitioned into equally sized (i.e., 512 MB) trust zones in accordance with TZM principles. TZM trust zone features, including their size, locations in the address space, and base security attribute, are static.

Resources (e.g., data, software, etc.) are stored in memory components (e.g., flash memory), which in turn are mapped to trust zones. Thus, resources are mapped to trust zones. Each trust zone is assigned one or three base security attributes: secure (S), non-secure (NS), and non-secure callable (NSC). Although not shown in FIG. 1, only one non-secure callable trust zone exists in a TZM address space. It should be noted that multiple non-secure trust zones can exist in an address space. However, the present invention will be described with reference to a single non-secure trust zone.

A resource, such as data held in a register, is considered secure when it is mapped to a secure trust zone, a resource, such as a software component, is considered non-secure when it is mapped to a non-secure trust zone, and a resource is considered non-secure callable when it is mapped to the non-secure callable trust zone.

TZM employs a device called an Authentication Unit (AU) that determines the base security attribute of addresses specified by the CPU during the address phase of access transactions. In other words, the AU determines if a CPU specified address is secure, non-secure, or non-secure callable. An address specified by a CPU during an address phase of a memory access transaction (hereinafter transaction) will be considered secure, non-secure, or non-secure callable, depending on the trust zone in which the address is contained. In other words an address is considered secure, non-secure, or non-secure callable when it is contained in a secure, non-secure, or non-secure callable trust zone, respectively.

TZM requires a CPU to operate in one of two base security states: secure or non-secure. Special instructions can switch the base security state of the CPU form non-secure to secure, or from secure to non-secure. These special instructions should only be contained in a software component called the “Security Gateway.” The Security Gateway should only be mapped to the non-secure callable trust zone. As will be more fully described, the Security Gateway consists of components called Veneers. SG is the special instruction that, when executed, transitions the base security state of the CPU from non-secure to secure. Each Security Gateway Veneer should include only one instance of the SG instruction. The Security Gateway, including its Veneers, will be more fully described below.

TZM requires the base security state of a CPU to be compatible with the base security attribute of the address specified by the CPU during a transaction. Stated differently, the base security state of software component executing on the CPU must be compatible with the base security attribute of the address the software component is attempting to access. If the base security attribute of the address is determined to be non-secure or non-secure callable (e.g., the address corresponds to a Veneer entry point located in the non-secure callable trust zone), the CPU, and thus the executing software component, is permitted to access content (e.g., data or instruction) at the address regardless of the CPU's base security state. If the address is determined to be secure, the CPU will be allowed to access content at the address only if the CPU is in the secure state. Thus, if the address is deemed secure and the CPU is in the non-secure state, the CPU's access to content at the address is blocked.

The security compatibility requirement is the basis for protecting resources against unauthorized access. This concept can be explained with reference to function calls. Functions are examples of self-contained software components that accomplish a specific task when called. Functions usually take in and process data. A function may also return a result. Once a function is written and programmed into flash memory, it can be used over and over again simply by calling it from various points in a main application or other software component. Functions can be called from inside other functions.

Functions, like other resources, are mapped to secure, non-secure, or non-secure callable trust zones. When software executing on a CPU attempts to call a function, the AU determines the base security attribute of the address of the function. The base security attribute of the address is compared to the base security state of the CPU at that time. If the entry point o the called function is mapped to a non-secure or a non-secure callable trust zone, the function call will not be blocked. If the function is mapped to a secure trust zone, the function call will not be blocked if the CPU is in the secure state. If the function is mapped to a secure trust zone and the CPU is in the non-secure state, the function call will be considered unauthorized and will be blocked.

TZM provides a Security Gateway as mentioned above. The primary purpose of the Security Gateway is to enable legitimate calls to a secure function or access to other secure resource by a non-secure software component. In other words the Security Gateway operates by providing a legitimate, indirect way through which non-secure software can call a secure resource including secure functions.

The Security Gateway is mapped to the non-secure callable trust zone as noted above. The Security Gateway contains security-state-transition wrapper code called Veneers, each of which has a callable entry point. In computer programming, an entry point is where control is transferred from one software component to another software component, at which place the CPU enters the other software component and execution begins. Each Veneer of the Security Gateway corresponds to a respective secure function that provides a service when called. A software component executing on the CPU can call a Veneer instead of directly calling secure function that corresponds to the Veneer. Because each Veneer entry point is mapped to the non-secure callable trust zone, the software's call to the Veneer will not be blocked even though the CPU may be in the non-secure state at the time. For the purposes of explanation, it will be presumed the CPU is in the non-secure state when the software component calls the Veneer. The called Veneer operates to change the base security state of the CPU from non-secure to secure using SG, the special instruction mentioned above. After the base CPU security state is changed, the Veneer directly calls the corresponding secure function. This call will not be blocked since the base security state of the CPU has been switched to secure. The secure function performs its service while the CPU is in the secure state. Once the service is rendered and control is returned to the Veneer, the Veneer changes the base security state of the CPU back to non-secure using another special instruction. After the base state of the CPU is returned to the non-secure, the CPU continues to execute the software component from the point where it called the Veneer.

As noted above, TZM limits base security attributes of trust zones to three types: secure, non-secure, and non-secure callable. TZM also limits the base security state of the CPU to secure and non-secure. Both limitations present problems. One problem relates to unfettered memory access by a software component executing on the CPU while in the secure state. Any software executing on the CPU while in the secure state can access any secure resource (i.e., a resource mapped to a secure trust zone) as described above. For example, while a called secure function is executing on the CPU, the function has unfettered access to all other secure resources, including secure data. This results in an inability to prohibit any secure resource from being accessed by a software component executing on the CPU while in the secure state.

Another problem with TZM is the simplistic approach to trust zone configurations. FIG. 1 shows an SoC address space, which is partitioned into 512 MB trust zones. This rigid partitioning can cause address space fragmentation, thus requiring support of noncontiguous flash and/or RAM memory chunks, which adds to the complexity of hardware design. The inflexible nature of TZM trust zone boundaries prohibit multiple, adjacent trust zones of the same memory type. The forced symmetry is non-optimal for mapping diverse resources to appropriate trust zones. The boundaries or locations of the TZM trust zone are static, which may present difficulties in software layout of multiple components that require different security attributes. Other disadvantages exist.

### Extended Secure Trust Zones and Extended CPU Secure States

The present invention addresses the foregoing problems and others. Like TZM, the present invention employs secure, non-secure and non-secure callable secure trust zones. However, the secure trust zones of the present invention are extended; secure trust zones are assigned one of several different levels of security or trust. The type, size and location of the trust zones of the present invention can be dynamically assigned (i.e., they are not static). In addition, the present invention extends the secure state of the CPU. As before the CPU operates in the secure or the non-secure state. However, the present invention extends the secure state of the CPU to one of several different levels of security or trust. These concepts and the benefits they provide will be more fully described below.

### Extended Secure Trust Zone Security Attributes

The present invention employs four or more types of trust zones: non-secure, non-secure callable, and secure with two or more levels of trust. The present invention will be described with reference to six types of trust zones: non-secure, non-secure callable, and secure with four levels of trust, it being understood the present invention should not be limited thereto. For purposes of explanation, the secure trust zones will be designated: secure/trust-level-0 (S/TL0), secure/trust-level-1 (S/TL1), secure/trust-level-2 (S/TL2), secure/trust-level-3 (S/TL3). In the embodiment described below, only one non-securable callable trust zone is employed. In an alternative embodiment, more than one non-secure callable trust zone can be employed.

Trust zone configuration registers (TZCRs) are used to define features of respective trust zones, including identity, location in the SoC address space, size, and security attribute. The identities can be used to identify resources mapped to respective trust zones. The contents of the TZCRs can be modified. System configuration software can establish one or more features the trust zones by writing the appropriate values to the TZCRs at boot-time. TZCRs can be configured or reconfigured after the initial system configuration is performed.

### Security Configuration Controller

A device called a security configuration controller uses the TZCRs to identify the trust zones in which addresses are contained. With the trust zone identified, the security attribute (e.g., S/TL1) of the addresses can be determined.

### External Authentication Unit (EAU

The present invention will be described with reference to CPUs configured to operate in the secure state or the non-secure state, it being understood the present invention should not be limited thereto. The EAU extends the secure state of the CPU. The present invention will be described with one EAU provided for each CPU, it being understood the present invention should not be limited thereto. In an alternative embodiment an EAU may be provided for each instruction cache or data cache in the SoC.

The EAU defines a trust level of its CPU while it operates in the secure state. For purposes of explanation, the present invention will be described with reference to an EAU that defines one of four trust levels S/TL0-S/TL3 for its CPU, it being understood the present invention should not be limited to four trust levels. As its name implies, the EAU is a device that is external to the CPU.

The EAU protects secure resources from unauthorized access by secure software components. The present invention presumes address checking at the CPU level as described above; the CPU will be denied access to any secure resource if the CPU is in the non-secure state. In addition the EAU may block CPU access to a secure resource if the CPU is in the secure state. For example, if the security attribute of an address specified by the CPU during an access transaction is determined to be secure with a particular trust level (e.g., S/TL1), the transaction will be blocked by the EAU if the security attribute of the address is incompatible with the trust level of the CPU even though the CPU is in the secure state. In other words, if software component executing on a CPU attempts to call a function that is mapped to a trust zone with a security attribute of S/TL1, the EAU will block the call if the trust level of the CPU does not allow access to a resource with a security attribute of S/TL1.

In one embodiment, each EAU includes or is associated with a respective security state register (SSR). Each SSR holds a multibit value hereinafter referred to as a FENCE value. The FENCE value defines the extended secure state for a respective CPU. In one embodiment, each bit position of a FENCE value corresponds to a respective trust level. The present invention will be described with reference to a four-bit FENCE value (SSRb0-SSRb3), the bit positions of which correspond to four trust levels S/TL0-S/TL3, respectively, it being understood the present invention should not be limited four secure trust levels; fewer or more secure trust levels are contemplated. When all bits of the FENCE value for a CPU are set (i.e., the FENCE value is “1111”), the EAU will allow its corresponding CPU to access only non-secure and non-secure callable resources, unless the CPU is attempting execute instructions (e.g., “MOV Rn, #FENCE” where Rn is one of the SSR registers) of a Veneer as will be more fully described below. When all bits of the FENCE value for a CPU are cleared (i.e., the FENCE value is “0000”), the EAU circuit will not block access to a secure resource. In other words, the EAU will allow access to all secure trust zones by a software component executing on the CPU while in the secure state. It is noted again that in the described embodiment access to any secure trust zone (e.g., a S/TL3 secure trust zone) will be blocked at the CPU level if the CPU is operating in the non-secure state, and this is true regardless of the FENCE value in the corresponding SSR.

A FENCE value can have a mixture of set and cleared bits. Individually cleared bits enable CPU access to secure resources with corresponding security attributes, and individually set bits disable CPU access to secure resources with corresponding security attributes. For example, with a FENCE value equal to “0101,” the EAU circuit will allow its CPU to access resources mapped to secure trust zones assigned security attributes S/TL3 or S/TL1, and the EAU circuit will block attempts by the CPU to access resources mapped to secure trust zones assigned security attributes S/TL2 or S/TL0.

Instructions located in extended Veneers can update the FENCE values in the SSRs. These extended Veneers, and thus the instructions thereof, are only available in an “Extended Security Gateway,” which is mapped to the non-secure callable trust zone. The extended Veneers will be more fully described below.

### Example Architecture

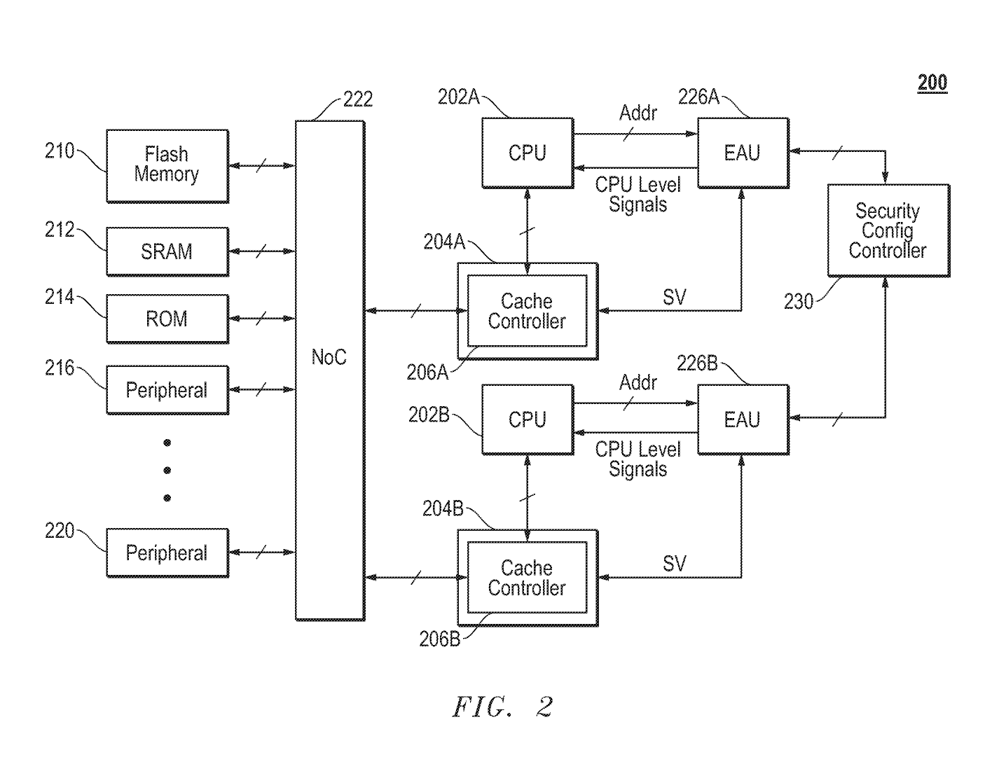

FIG. 2 illustrates an example SoC 200 that employs the foregoing concepts, it being understood the present invention should not be limited thereto. SoC 200 includes two CPUs 202, which are coupled to memory devices and peripherals 210-220 via communication system 222. For purposes of explanation, CPU 202A is substantially similar or identical to CPU 202B. Communication system 222 can take form in an NoC.

Most modern CPUs operate in conjunction with instruction and data caches, both of which are well known in the art. Each cache includes a cache controller. For ease of illustration and explanation, FIG. 2 shows only one cache 204 and its corresponding cache controller 206. Cache 204 may take form in either a data cache or an instruction cache. The present invention will be described with reference to a security system that blocks access transactions at cache controller 206.

CPUs 202 are coupled to respective EAU circuits 226, which in turn are coupled to a security configuration controller circuit 230. The combination of security configuration controller circuit 230 and EAU circuits 226 act in concert to prevent unauthorized access of secure resources. Security configuration controller circuit 230 determines the coded security attribute of an address specified by CPU 202 during an access transaction. If the security attribute is incompatible with the FENCE value defined in the corresponding SSR, EAU 226 asserts a security violation (SV) signal, unless CPU 202 is executing instructions of a Veneer as will be more fully described below. EAU 226 transmits the SV signal to the cache controller 206, which takes appropriate action to abort an access transaction in response to an assertion of the SV signal. EAU 226 also generates CPU level signals for its corresponding CPU based on coded security attribute. These signals are used to check the base security attribute (i.e., secure, non-secure, or non-secure callable) of addresses against the base security state of the CPU (i.e., secure or non-secure) for compliance.

EAUs 226 and security configuration controller 230 take form in hardware that is external to CPUs 202. Because the EAUs 226 and security configuration controller 230 are implemented in hardware, they act quickly so that the EAU decision to block access is made during the address phase of an access transaction, which is well in time to abort the transaction during the first bus-cycle of the corresponding data-phase.

### Security Configuration Controller

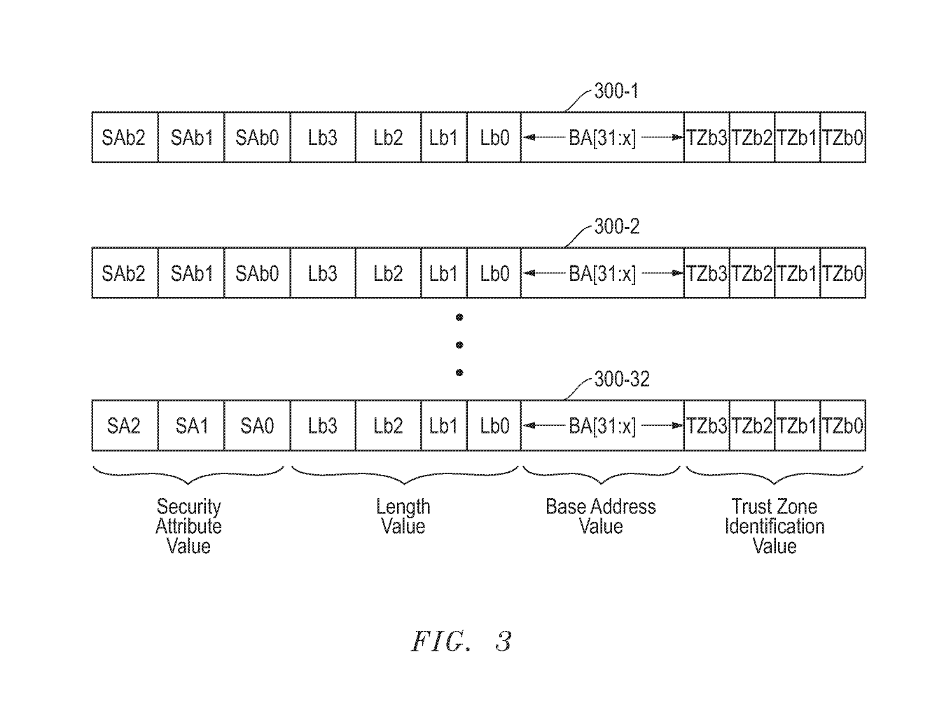

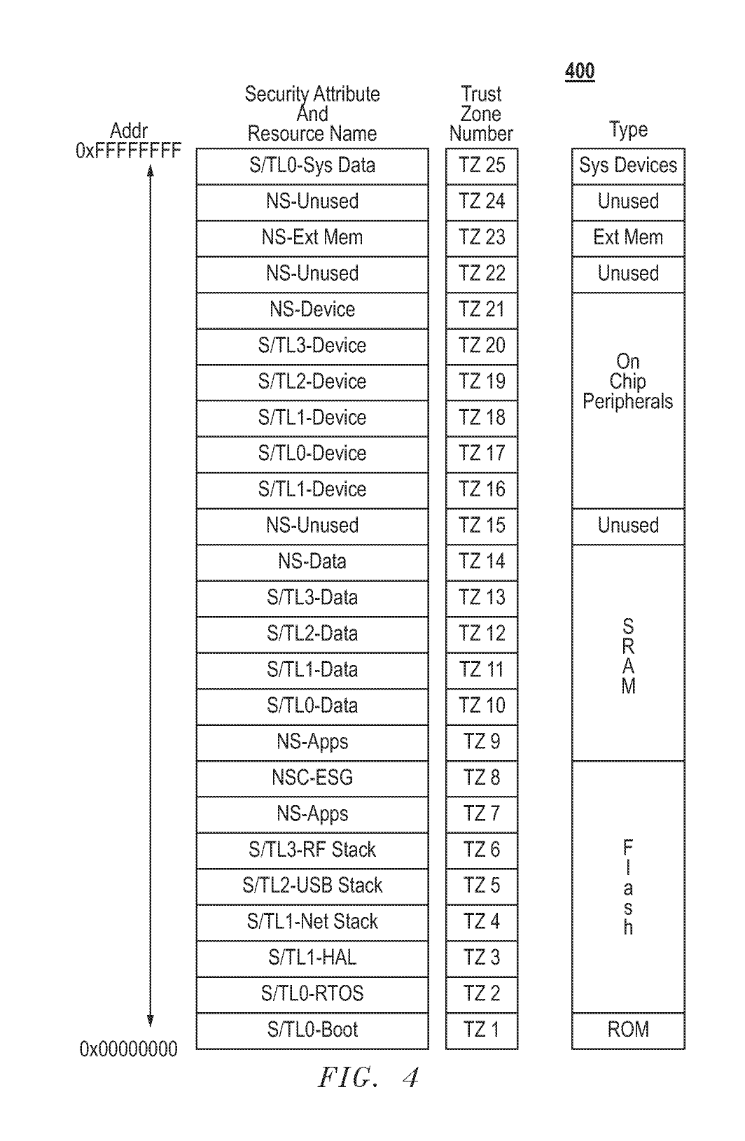

As noted above, the present invention employs TZCRs to define respective trust zones. With continuing reference to FIG. 2, FIG. 3 illustrates 32 TZCRs 300 employed in the example security configuration controller 230, it being understood the present invention should not be limited to 32 TZCRs. With continuing reference to FIGS. 2 and 3, FIG. 4 illustrates an example address space 400 of SoC 200, which is partitioned into trust zones via TZCRs 300. FIG. 4 shows resources mapped to respective secure and non-secure trust zones. Address space 400 also shows the non-secure callable trust zone into which an Extended Security Gateway (ESG) is mapped. While security configuration controller 230 contains 32 TZCRs, only 25 of them are used to partition address space 400 in the illustrated example. The 25 TZCRs that are used correspond to the 25 secure, non-secure, and non-secure callable trust zones, respectively, shown in FIG. 4.

Each of the resources in FIG. 4 is identified by name (e.g., Boot, RTOS, HAL, ESG, Device-Drivers, Data RAM, etc.). FIG. 4 also identifies the type of SoC memory that physically contain resources. For example FIG. 4 shows the resource identified as HAL is physically stored in flash memory, while the resource identified as Boot is physically stored in ROM. Some of the trust zones shown in FIG. 4 are unequal in size even though they appear to be drawn otherwise. For example, the trust zone into which the “HAL” resource is mapped, is larger than trust zone into which the “Boot” resource is mapped.

Each TZCR 300 stores a multibit trust zone identification value that identifies a trust zone number (e.g., TZ20) for its corresponding trust zone. In the illustrated embodiment, TZCR 300 stores a four bit trust zone identification value (i.e., TZb3-TZb0), it being understood the present invention should not be limited thereto. In an alternative embodiment, five bit trust zone identification values (i.e., TZb4-TZb0) could be used to identify trust zone numbers. Each TZCR 300 also stores a base address BA [31:x] that defines the base or starting address of its corresponding trust zone in address space 400. The present invention will be described with reference to 32-bit addresses. In the illustrated embodiment, BA comprises the upper bits (i.e., [31:x]) of a trust zone's starting address.

Additionally, each TZCR 300 stores a length value that is encoded in four bits (i.e., Lb0-Lb3). The length value defines the size of a corresponding trust zone. Table 1 below shows example encodings for the trust zone length values, although the present invention should not be limited thereto.

TABLE 1

| Lb3 | Lb2 | Lb1 | Lb0 | Trust Zone Size |
|---|---|---|---|---|
| 0 | 0 | 0 | 0 | 4 KBytes |
| 0 | 0 | 0 | 1 | 8 KBytes |
| 0 | 0 | 1 | 0 | 12 KBytes |
| 0 | 0 | 1 | 1 | 16 KBytes |
| 0 | 1 | 0 | 0 | 32 KBytes |
| 0 | 1 | 0 | 1 | 64 KBytes |
| 0 | 1 | 1 | 0 | 96 KBytes |
| 0 | 1 | 1 | 1 | 128 KBytes |
| 1 | 0 | 0 | 0 | 256 KBytes |
| 1 | 0 | 0 | 1 | 512 KBytes |
| 1 | 0 | 1 | 0 | 768 KBytes |
| 1 | 0 | 1 | 1 | 1 MBytes |
| 1 | 1 | 0 | 0 | 128 MBytes |
| 1 | 1 | 0 | 1 | 256 MBytes |
| 1 | 1 | 1 | 0 | 384 MBytes |
| 1 | 1 | 1 | 1 | 512 MBytes |

Lastly, each TZCR 300 stores a three bit security attribute value (i.e., SAb0-SAb2) that encodes the security attribute (e.g., S/TL1) for its corresponding trust zone. Table 2 shows example encodings for the security attributes, although the present invention should not be limited thereto.

TABLE 2

| SAb2 | SAb1 | SAb0 | Security Attribute |
|---|---|---|---|
| 0 | 0 | 0 | S/TL0 |
| 0 | 0 | 1 | S/TL1 |
| 0 | 1 | 0 | S/TL2 |
| 0 | 1 | 1 | S/TL3 |
| 1 | 0 | 0 | Invalid |
| 1 | 0 | 1 | NSC |
| 1 | 1 | 0 | NS |
| 1 | 1 | 1 | No Security Check |

The trust zone number, base address, length, and/or security attribute of a trust zone can be configured or reconfigured by modifying the contents of its corresponding TZCR 300. In one embodiment, the contents of TZCRs 300 can be modified by platform software, which can be mapped to a secure trust zone, in order to accommodate changes needed by embedded software to accommodate an update while the SoC is in the field.

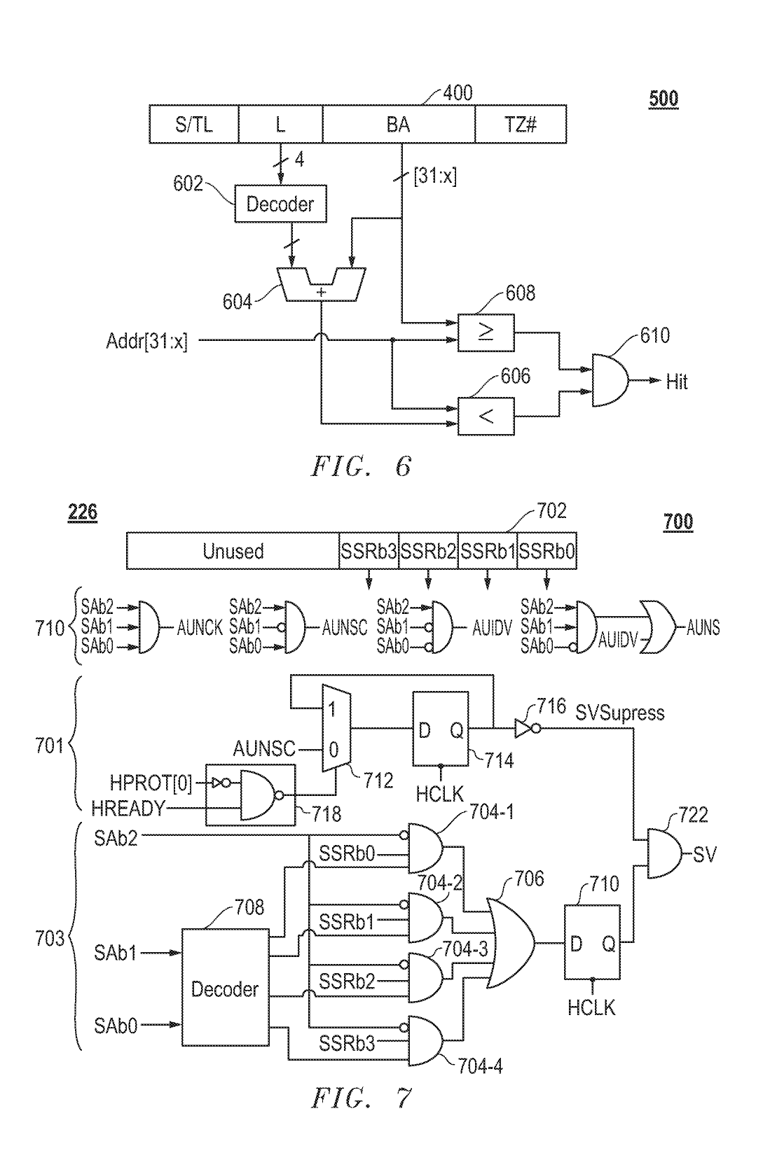

Security configuration controller 230 uses the contents of TZCRs 300 to determine the trust zone containing a data or instruction address ADDR that is specified by CPU 202 during an access transaction AT. With continuing reference to FIGS. 2-4, FIG. 5 illustrates relevant components of an example embodiment of security configuration controller 230. Security configuration controller 230 includes TZCRs 300 shown in FIG. 3. Security configuration controller 230 also includes respective hit detectors 500. FIG. 6 illustrates relevant components of an example embodiment of hit detector 500. Each hit detector 500 receives the upper bits of address ADDR (i.e., ADDR [31:x]). Each hit detector 500 also receives the base address BA [31:x] and encoded trust zone length value (i.e., Lb3-Lb0) from its corresponding TZCR 300. A trust zone length decoder 602 decodes the encoded trust zone length value into a corresponding multi bit value in accordance with Table 1 above. Adder 604 adds the output of decoder 602 to base address BA [31:x] to generate an upper reference address for the trust zone defined by the corresponding TZCR. Comparator 606 compares the upper reference address to ADDR [31:x]. Another comparator 608 compares ADDR [31:x] to base address BA [31:x], a lower reference address for the trust zone. If ADDR [31:x] falls between the upper and lower reference addresses, inclusively, AND gate 610 asserts a range hit signal indicating that ADDR [31:x] is located in its corresponding trust zone.

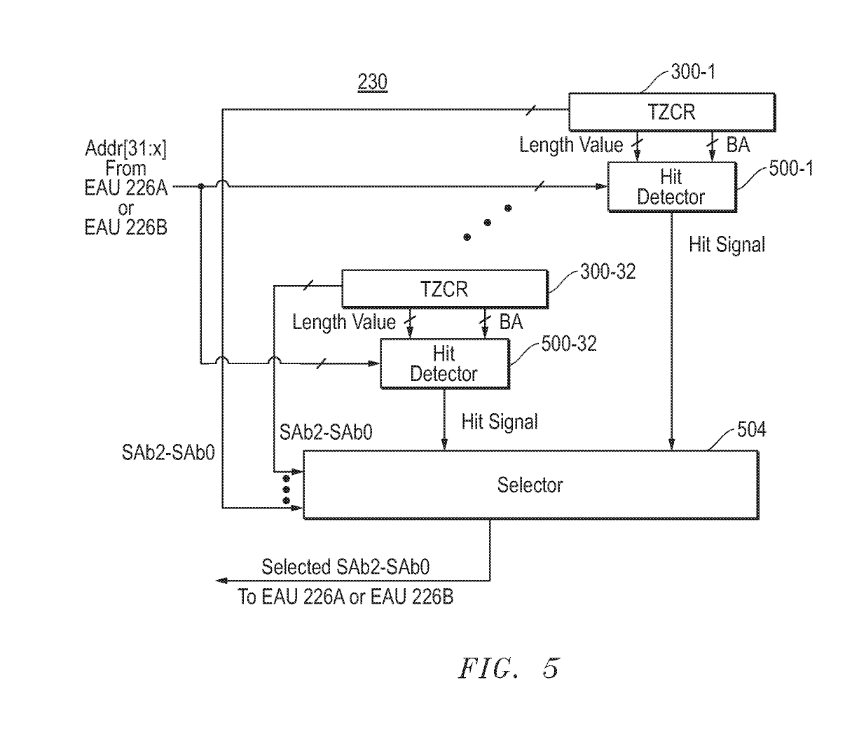

Returning back to FIG. 5, selector 504 receives outputs from hit detectors 500. In addition, selector 504 receives the encoded security attribute value (i.e., SAb0-SAb2) from each of the TZCRs 300. Selector 504 may also receive the trust zone identification number from each of the TZCRs. One and only one of the hit detectors 500 will assert its range hit signal in response to security configuration controller 230 receiving ADDR [31:x]. Selector 504 selects the encoded attribute security value that corresponds to the hit detector 500 that asserted its range hit signal. The selected encoded security attribute value is provided to the EAU 226 that provided ADDR [31:x]. In this manner, security configuration controller 230 essentially determines the encoded security attribute value for address ADDR [31:x] that is specified by CPU 202 during an access transaction. Selector 504 may also select and provide the trust zone identification number that corresponds to the hit detector 500 that asserted its range hit signal.

### External Authentication Unit (EAU)

EAU 226 checks the security attribute for each address ADDR generated by CPU 202 against the FENCE value in its corresponding SSR. With continuing reference to FIGS. 2-6, FIG. 7 illustrates relevant components of an example EAU circuit 226. As shown EAU 226 includes or is associated with a local SSR 702 that contains a four bit FENCE value (i.e., SSRb3-SSRb0) for CPU 202. SSRb3-SSRb0 correspond to S/TL3-S/TL0, respectively, as noted above. SSRb3-SSRb0 defines the extended secure state for CPU 202. In other words, SSRb3-SSRb0 defines access privileges for CPU 202 during a secure access transaction. In one embodiment, when bit SSRbx is set to logical one, EAU 226 denies CPU 202 access to an instruction or data at address ADDR with security attribute S/TLx, unless the access occurs while the CPU is fetching or executing an instruction in the non-secure callable trust zone as will be more fully described below. Thus, with SSRb3-SSRb0 set to “1010,” EAU 226 should block CPU access to content at addresses with security attributes S/TL3 or S/TL1, and EAU 226 will allow CPU access to content at addresses with security attributes S/TL2 or S/TL0. The FENCE values in SSRs 702 can be modified by instructions in Veneers as will be more fully described below.

EAU 226 includes a security violation (SV) circuit 700. This circuit asserts SV (i.e., SV is logical 1) when the corresponding CPU is attempting to access content at an address ADDR with a secure trust level that is incompatible with the trust level of the CPU. The SV circuit, however, will not assert the SV signal when the CPU is attempting to access content at an address ADDR specified by the CPU when it fetches or executes non-secure callable instructions. A corresponding cache controller 204 receives the SV signal as shown in FIG. 2. The cache controller blocks CPU access during the data phase of a transaction when SV is asserted.

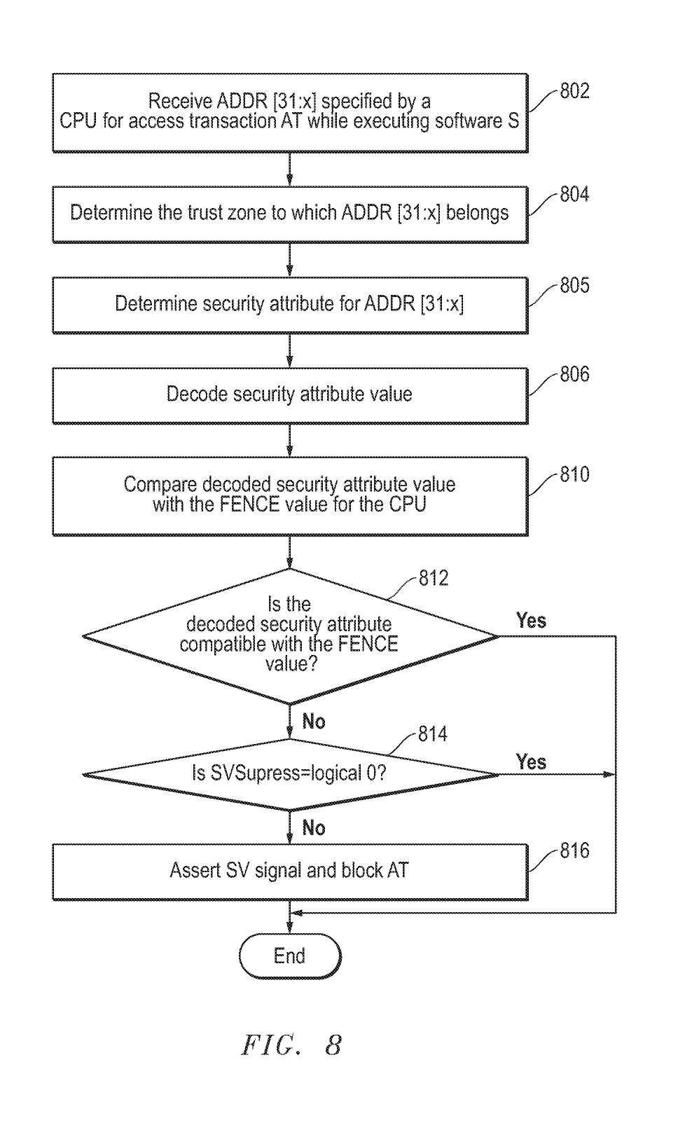

With continuing reference to FIG. 7, SV circuit 700 includes a SV suppression circuit 701 and an extended secure state check circuit 703. EAU 226 also includes a decoder 710 that generates AUNCK, AUNSC, AUNS, and AUIDV for its CPU 202 based on the encoded security attribute SAb2-SAb0 provided for address ADDR by selector 230. These signals encode the base security attributes of each address ADDR. Table 3 below shows an example encoding.

TABLE 3

| | | | Base Security |
|---|---|---|---|
| AUNCK | AUNS | AUNSC | Attribute |
| 1 | X | X | No CPU Level Check |
| 0 | 1 | X | Non-Secure |
| 0 | 0 | 0 | Secure |
| 0 | 0 | 1 | Non-Secure Callable |

The base security attribute for address ADDR is checked against the base security state at the CPU level as described above.

The extended secure state check circuit 703 checks the decoded security attribute for ADDR against the FENCE value in the corresponding SSR 702. The extended secure state check circuit 703 includes AND circuits 704, OR circuit 706, decoder 708, D flip-flop 710, AND gate 722. Each of the AND circuits 704 receives an inversion of SAb2, the most significant bit of the encoded security attribute value provided by selector 504. When SAb2 is set, the EAU circuit will not block CPU 202's access attempt regardless of the FENCE value in SSR 702 since the access attempt is directed to a trust zone that is not secure. Decoder 708 receives and decodes lower bits SAb1 and SAb0 of the selected security attribute value. The outputs of decoder 708 are provided to AND gates 704 as shown. Only one of the four outputs of decoder 708 should be asserted in response to decoder 708 receiving bits SAb1 and SAb0. For example, with SAb1 and SAb0 set, decoder 708 will only assert the output provided to AND gate 704-4. AND gates 704 also receive respective bits of the FENCE value held in SSR 702 as shown. OR gate 706 asserts its output signal if any of the AND gates 704 assert its output, which indicates an access transaction is unauthorized and should be blocked. To illustrate operation, assume CPU 202 specifies an address ADDR [31:x] while CPU 202 executes software component S. Further assume the FENCE value in SSR 702 is set to “1010.” EAU 226 receives SAb2=0, SAb1=1, and SAb0=0 as the encoded security attribute value determined by selector 504 for ADDR [31:x]. In this example, decoder 702 will decode the lower bits of the security attribute value and assert the output signal provided to AND gate 704-2. With SSRb1=1 as an input, AND gate 704-2 will assert its output. OR gate 706 will then assert its output signal, which in turn is latched by D flip-flop 710. Assuming the corresponding CPU is not fetching or executing an instruction from the non-secure callable trust zone, both inputs to AND gate 722 will be asserted, which in turn asserts the SV signal. Cache controller 224 blocks the attempted access by the software component S in response to assertion of the SV signal.

The SV suppression circuit 701 suppresses operation of the extended secure state check circuit 703 when the corresponding CPU is executing an instruction of a Veener. With SV extended secure state check circuit 703 suppressed, the CPU can access a secure resource even though the security attribute of the resource (i.e., SSR 702) is incompatible with the extended security state of the CPU as defined in its respective SSR 702. Suppression circuit 701 includes multiplexer 712, D flip-flop 714, invertor 716, and multiplexer controller circuit 718. In general SV suppression circuit 701 outputs SVSupress=logical 1 to AND gate 722 when the corresponding CPU is executing an instruction located outside the non-secure callable trust zone. However, SV suppression circuit 701 outputs SVSupress=logical 0 to AND gate 722 when the corresponding CPU is executing an instruction located inside the non-secure callable trust zone. When this happens, extended secure state check circuit 703 cannot not assert SV even though the CPU is attempting to access an address ADDR with a security attribute that is incompatible with SSRb3-SSRb0.

In the disclosed embodiment CPU 202 implements pipeline processing in which RISC instructions are executed in stages that include, for example, fetch, decode, execute, and data transfer. Multiplexer control circuit 718 receives status signals (e.g., HPROT[0] and HREADY) that correspond to the pipeline stages. In the illustrated example, HPROT[0] is asserted high when an instruction is being fetched, and HREADY is asserted when a prior data transfer is being completed. During a fetch of an instruction from the non-secure callable trust zone, the AUNSC signal will be asserted to logical 1 as noted above. With HPROT[0]=logical 0 and with HREADY=logical 1 while the non-secure callable instruction is fetched, multiplexor control circuit 718 generates a logical 0, which causes multiplexer 712 to select AUNSC for input to D flip-flop 714. As a result D flip-flop 714 will capture AUNSC=logical 1. And D flip-flop 714 will continue to hold AUNSC=logical 1, and as a result SVSuppress=logical 0, until an instruction outside of the non-secure callable region is fetched. When that happens, D flip-flop will capture and hold AUSNC=logical 0, which in turn flips the SVSupress signal to logical 1. With SVSupress at logical 1, the EAU circuit 700 will block accesses to an address with a security attribute that is incompatible with extended security state of the CPU as defined in the corresponding SSR register 702.

FIG. 8 illustrates relevant steps of an example process performed by EAU circuit 700 and security configuration controller 230 during the address phase of an access transaction AT. As shown, the process in FIG. 8 begins with step 802 when EAU 226 receives address ADDR [31:x] specified by CPU 202 during the address-phase of access transaction AT. EAU 226 forwards the upper bits ADDR [31:x] to security configuration controller 230. In step 804 security configuration controller 230 uses ADDR [31:x] to determine the trust zone in which ADDR [31:x] is contained. EAU 226 receives the security attribute value SAb1-SAb2 from security configuration controller 230 for the trust zone determined in step 804. The extended secure state check circuit 703 of EAU 226 decodes the security attribute value for ADDR [31:x] in Step 806. The extended secure state check circuit 703 of EAU 226 compares the decoded security attribute with the FENCE value specified by SSR 702 in step 810. If the security level of ADDR [31:x] is incompatible with the FENCE value, and if suppression circuit 701 outputs SVSuppress=logical 1 to AND circuit 722, EAU 226 asserts the SV signal in step 814, which causes cache controller 224 to abort transaction AT. This action in turn causes a bus fault exception. Assertion of the SV signal also causes the capture of information (e.g., the security attribute and trust zone number determined in steps 804 and 805, the offending address ADDR, Bus Interface signals, etc.) in a fault register (not shown) of EAU 226 for further processing by a bus exception handling routine.

If EAU 226 determines the FENCE value in SSR 702 complies with the decoded security attribute of ADDR [31:x], and if suppression circuit 701 outputs SVSupress=logical 1 to AND circuit 722, then EAU 226 will not assert the SV signal, cache controller 224 allows the transaction AT to proceed, and resource R is accessed accordingly.

EAU 226 will block any attempt by CPU 202 to directly access a secure resource when SSR 702 holds a FENCE value that is incompatible with the security attribute of the resource, unless CPU is attempting to access the secure resource in response to executing an instruction in the non-secure callable trust zone. Accordingly, software S executing on CPU 202 cannot directly call a secure software resource if the security attribute of the secure trust zone to which the resource is mapped, is incompatible with the FENCE value in SSR 702. However, the present invention provides an Extended Security Gateway (ESG) through which software component S can indirectly call a secure software service that is mapped to a trust zone with a secure trust level that is incompatible with the extended secure state of software component S. The present invention will be described with reference to software component S attempting to call secure function F.

ESG contains extended Veneers, each of which has a callable entry point. The ESG is mapped to the non-secure callable trust zone, which means CPU 202 can directly call an extended Veneer regardless of CPU 202's security state or regardless of the FENCE value in SSR 702. Each extended Veneer corresponds to a respective secure function or other secure software resource. Software S executing on the CPU 202 calls an extended Veneer instead of calling a function F directly. A special instruction SG of the called extended Veneer causes the base security state transition of the CPU to secure, and a set of protected instructions of the called extended Veneer updates the FENCE value in SSR 702 to a value that is compatible with the security attribute of the trust zone to which function F is mapped. After the FENCE value is updated, the extended Veneer directly calls the corresponding function F. EAU 226 will not block this call since CPU 202 is now in a secure state and the FENCE value in SSR 702 is compatible with the security attribute for function F. Once the service provided by function F is rendered, the extended Veneer returns the FENCE value of SSR 702 to what it was before, using another set of protected instructions. In addition the extended Veneer changes the base security state of CPU 202 back to what it was before, by using another special instruction. Thereafter CPU 202 continues to execute software component S. It is not possible for software component S to fake an extended Veneer since: all legitimate extended Veneers must start with special SG instruction and must be located in the non-secure callable trust zone; the extended Veneers are created by highly trusted platform build software, and loaded in the Flash Memory in a secure manufacturing site. The non-secure trust zone is configured during secure boot by highly trusted secure configuration code.

Each extended Veneer contains instructions that can update SSR 702 by storing a new FENCE value in SSR 702, call a corresponding software resource such as a function F, and returning SSR 702 back to its previous FENCE value. The Veneers may be identical to each other except for the instruction to load the new FENCE value into SSR 702 and the instruction to call a corresponding secure software resource. In one embodiment, a “MOV Rn, #FENCE” instruction of the extended Veener defines a new FENCE value, “#FENCE,” to be loaded into SSR 702, and a “BL ServiceFunction1” instruction calls secure software resource “ServiceFunction1.” #FENCE is compatible with the security attribute of the secure software resource ServiceFunction1 sought to be indirectly accessed by software S. #FENCE can vary between Veneers and is dictated by a security policy being employed determined by the configuration address map of the application being deployed in SoC 200. Some Veneers may use the same #FENCE value. The BL ServiceFunction1 instruction, which, when executed by CPU 202, calls the appropriate secure software resource after MOV Rn, #FENCE, etc., updates the FENCE value in SSR 702. After the requested secure software resource has rendered is function, the extended Veneer restores the FENCE value in SSR 702 to the value it was before the extended Veneer was called.

CPU 202 access to extended secure resources depends on an access policy implemented through the address map configuration deployed in the SoC. Address map configurations are flexible and can be implemented by selection of security attributes assigned to trust zones, and the #FENCE value used in the MOV lr, #FENCE, etc., instructions of the extended Veneers. Address map configurations can enforce, for example, coequal or hierarchical access rights. A co-equal policy for access rights would prohibit a software element mapped to a secure trust zone with one level of trust from directly accessing a resource mapped to a secure trust zone at a different trust level; the software element could access only secure resources with the same trust level. A hierarchical policy would permit a software element mapped to a secure trust zone with one level of trust to directly access a resource mapped to a secure trust zone with a lower trust level. In an address map configuration that is hierarchical in nature, for example, the trust level of a trust zone at trust level S/TL0 is higher than that of S/TL1, which is higher than S/TL2, which is higher than S/TL3. This means: S/TL0 software (i.e., software mapped to an S/TL0 trust zone) can directly access any secure resource in address space 300; S/TL1 software can directly access any secure resource in address space 300, except for S/TL0 resources; S/TL2 software can directly access any secure resource in address space 300, except for S/TL1 and S/TL0 resources; S/TL3 software can directly access any secure resource in address space 300, except for S/TL1, S/TL2, and S/TL0 resources.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
a first central processing unit (CPU) specifying a first address;
identifying a security attribute for the first address, wherein the security attribute is one of at least four security attributes;
denying CPU access to a memory location identified by the first address based on the identified security attribute.

2. The method of claim 1 wherein the act of denying CPU access is based on a security state for the CPU.

3. The method of claim 2 further comprising an act of comparing the security attribute for the first address with the security state for the CPU, wherein the CPU is denied access in response to a determination that the security state for the CPU is incompatible with the security attribute for the first address.

4. The method of claim 1 further comprising an act of identifying a first range of addresses within an address space that contains the first address, wherein the security attribute for the first address is identified in response to identifying the first range.

5. The method of claim 4 further comprising an act of calculating the first range of addresses based on information contained in a first register.

6. A method implemented by an integrated circuit comprising a first CPU, wherein the method comprises:
the first CPU specifying a first address in response to the first CPU executing a first instruction of a first software component;
denying access to a first memory location identified by the first address if a security attribute for the first address is incompatible with a security state for the first CPU;
allowing access the first memory location if the security attribute for the first address is compatible with the security state for the first CPU;
wherein the security state for the first CPU defines one of at least three distinct security states for the first CPU.

7. The method of claim 6:
wherein the security state for the first CPU relates to an x-bit value;
wherein security state for the first CPU is one of 2^{x} security states.

8. The method of claim 6:
updating the security state for the first CPU to a different security state.

9. The method of claim 6 further comprising:
comparing the first address to a plurality of address ranges, wherein each of the address ranges is mapped to a respective security attribute;
wherein one of the address ranges comprises more addresses than another of the address ranges.

10. The method of claim 9 wherein each of the address ranges is defined by a respective starting address and address range length.

11. The method of claim 6 further comprising:
accessing the first memory location to fetch a first instruction, wherein the first instruction is one in a first set of instructions;
wherein the first instruction set comprises an instruction for calling a second software component.

12. The method of claim 11 wherein the first instruction set is one of a plurality of instruction sets that correspond to a plurality of software elements, respectively.

13. A memory for storing instructions that are executable by a first central processing unit (CPU), wherein a method is implemented in response to executing the instructions stored in the memory, the method comprising:
generate a first address for accessing a first memory location in an address space, wherein the CPU generates the first address;
denying first CPU access to the first memory location if a security attribute for the first address is incompatible with a security state for the first CPU;
allowing access to the first memory location if the security attribute for the first address is compatible with the security state for the first CPU;
wherein the security attribute for the first address defines one of at least four distinct security attributes;
wherein security state for the first CPU defines one of the at least three distinct security states.

14. The memory of claim 13:
wherein the security attribute comprises an x-bit value;
wherein the security attribute for the first address is one of 2^{x} security attributes.

15. The memory of claim 13 wherein the method further comprises:
comparing the first address to a plurality of address ranges, wherein each of the address ranges is mapped to a respective security attribute;
wherein one of the address ranges comprises more addresses than another of the address ranges.

16. The memory of claim 15 wherein each of the address ranges is defined in a respective register by a respective starting address and address range length.

17. The memory of claim 13 wherein the method further comprises:
accessing the first memory location to read a first instruction, wherein the first instruction is one in a first set of instructions;
executing the first instruction set;
changing the security state of the first CPU in response to executing the first instruction set;
wherein the first instruction set is one of a plurality of instruction sets;
wherein each of the plurality of instructions sets is configured to update the security state for the first CPU.

18. The memory of claim 16 wherein the plurality of instruction sets correspond to a plurality of software elements, respectively.

19. The memory of claim 18 wherein each of the plurality of instruction sets comprises a respective instruction for invoking the plurality of software elements, respectively.

20. A system on a chip (SoC) comprising:
memory comprising flash memory, random access memory, and register memory;
a first central processing unit (CPU) for generating a first address for accessing a first memory location in the memory;
a circuit for blocking access to the first memory location if a security attribute for the first address is incompatible with a security state of the first CPU
wherein the security state for the first CPU defines one of at least three distinct security states for the first CPU.
